(19) United States
(12) Patent Application Publication
(10) Pub. No.: US 2013/0076689 A1
(43) Pub. Date: Mar. 28, 2013

(54) MUTUAL CAPACITANCE TOUCH SCREEN TO CAUSE DISPERSED COUPLING OF ELECTRODES

(71) Applicant: FocalTech Systems, Ltd., Grand Cayman (KY)

(72) Inventors: Hua Li, Shenzhen (CN); Michael Mo, Shenzhen (CN)

(73) Assignee: FOCALTECH SYSTEMS, LTD., Grand Cayman (KY)

(21) Appl. No.: 13/621,993

(22) Filed: Sep. 18, 2012

(30) Foreign Application Priority Data
Sep. 21, 2011 (CN) 201120355255.1

(51) Int. Cl. G06F 3/044

(52) U.S. Cl. CPC G06F 3/044
USPC 345/174

(57) ABSTRACT

A mutual capacitance touch screen to cause dispersed coupling of electrodes includes driving electrode chains, sensing electrode chains and a data processing module. The central line of any driving electrode chain and the central line of any sensing electrode chain are mutually vertical. The driving electrode chains comprise at least two driving electrode plates. Two adjacent driving electrode plates are electrically connected by means of driving electrode connecting strips made of the conductive material. Thus, two clearances are formed between two adjacent driving electrode plates. Bar-shaped concave clearances which are recessed towards the driving electrode plates are also arranged on the driving electrode plates. The sensing electrode chains are arranged to fill the gaps and the concave clearances among the driving electrode chains in the touch screen. In the utility model, the coupling electric field is dispersed. Thus, the long range power lines in the coupling electric field are effectively reduced, the sensitivity of the touch screen in the hanging state is optimized, and the waterproof property and the anti-interference capability of the touch screen are improved. Moreover, the effective capacitivity of the mutual capacitance touch screen is also improved.

The present application claim priority of Chinese patent application Serial No. 201120355255.1, filed Sep. 21, 2011, the content of which is hereby incorporated by reference in its entirely.

### TECHNICAL FIELD

The present invention relates to a capacitive touch screen as an input device, and more particularly to a mutual capacitance touch screen manufactured based on a mutual capacitance principle.

### BACKGROUND ART

A conventional mutual capacitance touch screen includes a data processing module, a driving electrode electrically connected with a driving electrode interface of the data processing module, and a sensing electrode electrically connected with a sensing electrode interface of the data processing module. The driving electrode and the sensing electrode are mostly designed into parallel driving electrode strips and parallel sensing electrode strips. Moreover, any driving electrode strip and any sensing electrode strip are mutually vertical. Thus, mutual capacitance is formed at the intersection between the driving electrode strip and the sensing electrode strip. A mutual capacitance array in array arrangement is formed on the whole touch screen. When a finger or a special touch device touches the surface of the touch screen, a mutual capacitance value in the position of a touch point is changed. The change of the mutual capacitance value is sensed through the data processing module for judging the touched position of the touch screen. Accordingly, input data of touch information outputted to a data processing device is formed through processing. The data processing device is controlled by at least one CPU (Central Processing Unit), such as computer, PDA (Personal Digital Assistant), various digit videos with display screens, etc.

The mutual capacitance formed between the driving electrode and the sensing electrode includes intrinsic capacitance formed by that an electric field is free from external influence, and variable capacitance formed by that the electric field is subject to external influence. When the touch screen is touched, the finger or the special touch device changes the electric field to change the variable capacitance. The proportion of the capacitance change range of the variable capacitance in the mutual capacitance is known as effective capacitivity. It is obvious that the effective capacitivity can reflect the sensitivity of the mutual capacitance touch screen. Thus, the electrode design of the touch screen tries to minimize the intrinsic capacitance and increase the variable capacitance for obtaining higher effective capacitivity.

In addition, the electric field of the mutual capacitance array formed in the conventional mutual capacitance touch screen is more focused. With regard to the mutual capacitance formed, the mutual capacitance is formed at the intersection between the driving electrode and the sensing electrode and is not formed at other regions or the formed mutual capacitance is very small and insufficient to reflect the influence of touch on the change of the mutual capacitance. With regard to a coupling electric field, the focused coupling phenomenon of the driving electrode and the sensing electrode results in that there are many long range power lines in the coupling electric field. The long range power lines mean that the length of the power lines is very long and the power lines are often formed between two long-distance electrodes. When the touch screen is in a hanging state, namely that there is water on the surface of the touch screen, the finger or the special device touches the touch screen; the power lines between the electrodes are reduced due to touch and the long range power lines on the driving electrode are easy to be recoupled to the sensing electrode. Thus, the coupling capacitance between the driving electrode and the sensing electrode is not reduced, and may increase instead, resulting in that the variance of the mutual capacitance of touching the touch screen in the hanging state is very small. Under a serious condition, compared with static power lines of the touch screen, the coupling power lines on a screen body are not reduced, but increased instead. With regard to the mutual capacitance, the intrinsic phenomenon is that the capacitance of the touched region on the touch screen body is not reduced, but increased. Thus, the focused problem of the coupling electric field of the conventional mutual capacitance touch screen results in the reduction of the touch sensitivity in the hanging state. A user may feel poor waterproof property and poor anti-interference property of the touch screen.

### Invention Contents

In view of the above-described problems, the aims of the invention are to avoid defects in the prior art and to provide a mutual capacitance touch screen to cause dispersed coupling of electrodes. The coupling electric field formed between the driving electrode and the sensing electrode is dispersed by improving the shapes and the arrangement relationship of the driving electrode and the sensing electrode so as to reduce the long range power lines in the electric field.

The purpose of the invention is achieved by the following technical schemes:

A mutual capacitance touch screen to cause dispersed coupling of the electrodes is designed and manufactured and comprises at least one driving electrode chain made of conductive material, at least one sensing electrode chain made of conductive material, and a data processing module. The central line of any driving electrode chain and the central line of any sensing electrode chain are mutually vertical. The driving electrode chain is electrically connected with a driving electrode interface of the data processing module. The sensing electrode chain is electrically connected with a sensing electrode interface of the data processing module. Particularly, the driving electrode chains comprise at least two driving electrode plates. Two adjacent driving electrode plates are electrically connected by means of the driving electrode connecting strips made of the conductive material. Thus, two clearances are formed between two adjacent driving electrode plates. Bar-shaped concave clearances which are recessed towards the driving electrode plates are also arranged on the driving electrode plates. The sensing electrode chains comprise at least two sensing electrode plates. The sensing electrode plates comprise gap sensing electrodes and clearance sensing electrodes electrically connected with the gap sensing electrodes. Two adjacent sensing electrode plates are electrically connected together by means of the sensing electrode connecting strips which are respectively electrically connected with the two adjacent gap sensing electrodes. The sensing electrode connecting strips are made of conductive material. The shapes of the sensing electrode plates and the arrangement of the driving electrode chains and the sensing electrode chains enable all the driving electrode plats and the sensing electrode plates to satisfy that the driving electrode connecting strips between two adjacent driving electrode plates are intersected but not in electric contact with the sensing electrode connecting strips of a pair of adjacent sensing electrode plates in spatial positions. Respective gap sensing electrodes of two adjacent sensing electrode plates are respectively positioned in two gaps between two adjacent driving electrode plates. Respective clearance sensing electrodes of two adjacent sensing electrode plates are respectively positioned in the respective concave clearances of two driving electrode plates. The driving electrode plates and the sensing electrode plates are not in any electric contact.

Particularly, the sensing electrode plates also comprise at least one electrode plate inner connecting strip made of conductive material. The electric connection among the gap sensing electrodes and each clearance sensing electrode plate is realized by means of the electrode plate inner connecting strips for respectively electrically connecting the clearance sensing electrode plates with the gap sensing electrodes.

Two del driving electrode connecting notches which are recessed towards the driving electrode connecting strips are respectively arranged on both sides of the middle parts of the driving electrode connecting strips. Two del sensing electrode connecting notches which are recessed towards the sensing electrode connecting strips are respectively arranged on both sides of the middle parts of the sensing electrode connecting strips.

The central lines of the driving electrode chains are the centroid connecting lines of each driving electrode plate of the driving electrode chains. The central lines of the sensing electrode chains are the centroid connecting lines of each sensing electrode plate of the sensing electrode chains.

The driving electrode chains and the sensing electrode chains can belong to different planes. The driving electrode chains are positioned in the same driving electrode plane. The sensing electrode chains are positioned in the same sensing electrode plane. The driving electrode plane and the sensing electrode plane are mutually parallel. Further, an insulating medium is arranged between the driving electrode plane and the sensing electrode plane.

The driving electrode chains and the sensing electrode chains can also be positioned in the same electrode plane. Isolation media made of insulating material are arranged among the driving electrode connecting strips and the sensing electrode connecting strips which are mutually crossed, so that the driving electrode chains are unable to be electrically connected with the sensing electrode chains.

To further improve the effective capacitivity and reduce the long range power lines, a dummy electrode plate, which is made of conductive material and is in an electric hanging state, is also arranged in the intermittent region between adjacent driving electrode plate and sensing electrode plate. The electric hanging state means that the dummy electrode plate does not have any electric contact or electrical connection relationship with any driving electrode plate, any sensing electrode plate and any charged device.

The driving electrode plates are all rectangular. With regard to the arrangement of the concave clearance, one scheme is that at least one concave clearance whose central line is perpendicular to the electrode plate edge is arranged on the electrode plate edge of one driving electrode plate adjacent to an adjacent driving electrode plate; the other scheme is that concave clearances whose central lines are perpendicular to respective electrode plate edges are respectively arranged on two parallel electrode plate edges of one driving electrode plate on both sides of the driving electrode connecting strips. The two above schemes can also be combined into one scheme; at least one concave clearance whose central line is perpendicular to the electrode plate edge is arranged on the electrode plate edge of one driving electrode plate adjacent to an adjacent driving electrode plate; meanwhile, concave clearances whose central lines are perpendicular to respective electrode plate edges are respectively arranged on two parallel electrode plate edges of one driving electrode plate on both sides of the driving electrode connecting strips. Particularly, the concave clearances are symmetrically arranged on the driving electrode plates by using the central lines of the driving electrode chains as an axis of symmetry.

Compared with the prior art, the mutual capacitance touch screen to cause dispersed coupling of electrodes of the invention has the advantages:

1. Among the driving electrode plates and the sensing electrode plates, the coupling electric field is not only formed in the gap between two adjacent driving electrode plates, but also formed in the concave clearance of each driving electrode plate. Thus, the long range power lines in the coupling electric field are effectively reduced, the sensitivity of the touch screen in the hanging state is optimized, and the waterproof property and the anti-interference capability of the touch screen are improved.

2. No opposite region is arranged among the driving electrode plates and the sensing electrode plates. Thus, the proportion of the intrinsic capacitance in the mutual capacitance is greatly reduced, and the effective capacitivity of the mutual capacitance touch screen is improved.

### DESCRIPTION OF FIGURES

FIG. 1 is an arrangement diagram of a driving electrode chain 1 and a sensing electrode chain 2 in a first embodiment of a mutual capacitance touch screen to cause dispersed coupling of electrodes of the invention;

FIG. 2 is a schematic diagram of a driving electrode chain 1 of the first embodiment;

FIG. 3 is a schematic diagram of a sensing electrode chain 2 of the first embodiment;

FIG. 4 is a partial enlarged diagram of a driving electrode chain 1 and a sensing electrode chain 2 of one corner of a touch screen of the first embodiment;

FIG. 5 is a partial enlarged diagram of a driving electrode chain 1 and a sensing electrode chain 2 of one corner of a touch screen of a second embodiment of the invention;

FIG. 6 is a partial enlarged diagram of a driving electrode chain 1 and a sensing electrode chain 2 of one corner of a touch screen of a third embodiment of the invention;

FIG. 7 is a partial enlarged diagram of a driving electrode chain 1 and a sensing electrode chain 2 of one corner of a touch screen of a fourth embodiment of the invention;

FIG. 8 is a partial enlarged diagram of a driving electrode chain 1 and a sensing electrode chain 2 of one corner of a touch screen of a fifth embodiment of the invention.

### MODE OF CARRYING OUT THE INVENTION

The invention is further described in detail in accordance with embodiments shown in the figures.

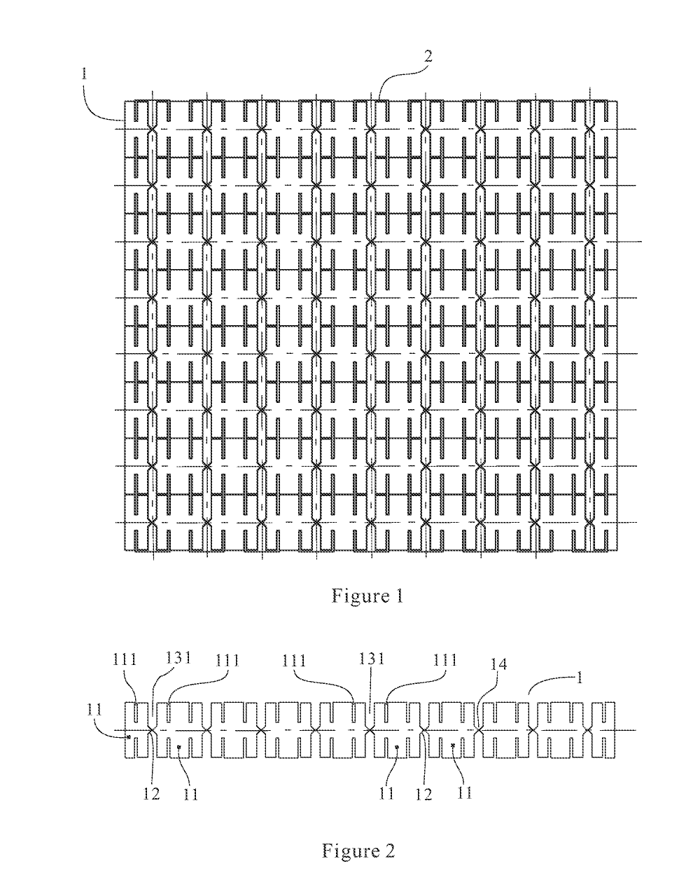

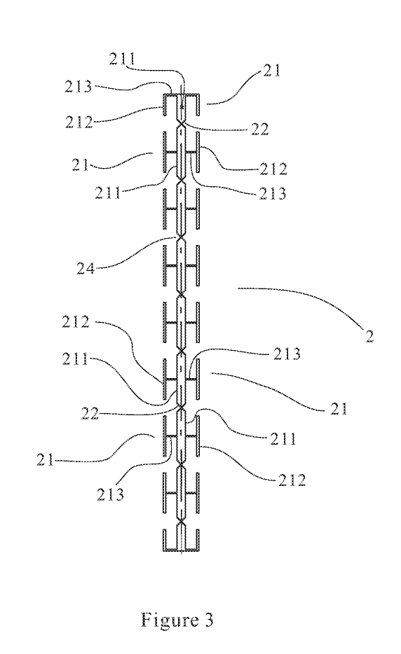

The invention provides a mutual capacitance touch screen to cause dispersed coupling of electrodes. As shown in FIG. 1 to FIG. 8, the mutual capacitance touch screen comprises at least one driving electrode chain 1 made of conductive material, at least one sensing electrode chain 2 made of conductive material, and a data processing module. The central line of any driving electrode chain 1 and the central line of any sensing electrode chain 2 are mutually vertical. The data processing module is used for electrically connecting each electrode chain 1 and 2, detecting the change of the mutual capacitance between two electrode chains, and carrying out data processing on the change of the mutual capacitance. The driving electrode chain 1 is electrically connected with a driving electrode interface of the data processing module. The sensing electrode chain 2 is electrically connected with a sensing electrode interface of the data processing module. Particularly, the driving electrode chains 1 comprise at least two driving electrode plates 11. Two adjacent driving electrode plates are electrically connected by means of the driving electrode connecting strips made of the conductive material. Thus, two gaps 131 are formed between two adjacent driving electrode plates 11. Bar-shaped concave clearances 111 which are recessed towards the driving electrode plates are also arranged on the driving electrode plates 11. The sensing electrode chain 2 comprises at least two sensing electrode plates 21. The sensing electrode plates 21 comprise gap sensing electrodes 211 and clearance sensing electrodes 212 electrically connected with the gap sensing electrodes 211. Two adjacent sensing electrode plates 21 are electrically connected together by means of the sensing electrode connecting strips 22 which are respectively electrically connected with the two adjacent gap sensing electrodes 211. The sensing electrode connecting strips 22 are made of conductive material. The shapes of the sensing electrode plates 21 are changed along with the change of the shapes of the driving electrodes. The sensing electrode chain almost fills gaps or concave clearances among all driving electrode chains in the touch screen. Moreover, the central lines of the sensing electrode chains 2 are perpendicular to the central lines of the driving electrode chains 1. Thus, the shapes of the sensing electrode plates 21 and the arrangement of the driving electrode chains 1 and the sensing electrode chains 2 enable all the driving electrode plates 11 and the sensing electrode plates 21 to satisfy the following conditions: the driving electrode connecting strips 12 between two adjacent driving electrode plates 11 are intersected but not in electric contact with the sensing electrode connecting strips 22 of a pair of adjacent sensing electrode plates 21 in spatial positions. Respective gap sensing electrodes 211 of two adjacent sensing electrode plates 21 are respectively positioned in two gaps 131 between two adjacent driving electrode plates 11. Respective clearance sensing electrodes 212 of two adjacent sensing electrode plates 21 are respectively positioned in the respective concave clearances 111 of two driving electrode plates 11. The driving electrode plates 11 and the sensing electrode plates 21 are not in any electric contact.

The mutual capacitance formed by coupling among the driving electrode plates 11 and the sensing electrode plates 21 of the invention comprises a plurality of dispersed mutual capacitances, i.e. mutual capacitance formed by coupling in each gap 131 and mutual capacitance formed by coupling in each concave clearance 111. In the technical scheme of the invention, the coupling electric field is dispersed; the mutual capacitance formed by coupling is also dispersed. The long range power lines in the coupling electric field are greatly reduced. Thus, the focused distribution problem of the coupling electric field in the prior art is overcome. When the touch screen is in a hanging state, because the long range power lines are greatly reduced, the power lines of forming the variable capacitance are not recoupled among the electrode plates by touching the touch screen, thus ensuring to keep higher effective capacitivity and touch sensitivity in the hanging state of the touch screen. The common hanging state of the touch screen is waterproof of the touch screen. Thus, the invention improves the waterproof property and the anti-interference capability of the touch screen. In addition, the sensing electrode chains 2 of the invention have the shape of the sensing electrode plates 21 for filling the gaps or clearances among the driving electrode chains 1 in the touch screen. Thus, the driving electrode chains 1 and the sensing electrode chains 2 are not opposite. Such arrangement can greatly reduce the intrinsic capacitance formed by coupling among the driving electrode chains 1 and the sensing electrode chains 2, so as to greatly improve the effective capacitivity of the touch screen.

With regard to the sensing electrode plates 21, particularly, the sensing electrode plates 21 also comprise at least one electrode plate inner connecting strip 213 made of conductive material. The electric connection among the gap sensing electrodes 211 and each clearance sensing electrode plate 212 is realized by means of the electrode plate inner connecting strips 213 for respectively electrically connecting the clearance sensing electrode plates 212 with the gap sensing electrodes 211.

The central lines of the driving electrode chains 1 are the centroid connecting lines of each driving electrode plate 11 of the driving electrode chains 1. The central lines of the sensing electrode chains 2 are the centroid connecting lines of each sensing electrode plate 21 of the sensing electrode chains 2.

All embodiments of the invention are suitable for the condition that the driving electrode chains 1 and the sensing electrode chains 2 belong to different planes. The driving electrode chains 1 are positioned in the same driving electrode plane. The sensing electrode chains 2 are positioned in the same sensing electrode plane. The driving electrode plane and the sensing electrode plane are mutually parallel. In this condition, generally, an insulating medium, such as glass, is arranged between the driving electrode plane and the sensing electrode plane. The invention is also suitable for the condition that the driving electrode chains 1 and the sensing electrode chains 2 are all in the same plane. When the driving electrode chains 1 and the sensing electrode chains 1 are positioned in the same electrode plane, isolation media made of insulating material are arranged among the driving electrode connecting strips 12 and the sensing electrode connecting strips 22 which are mutually crossed, so that the driving electrode chains 1 are unable to be electrically connected with the sensing electrode chains 2 to avoid a short circuit condition. When the isolation media are arranged, bridges are often arranged at the intersection between the driving electrode connecting strip 12 and the sensing electrode connecting strip 22, so that two connecting strips 12 and 22 are mutually in a crossing position relationship. Meanwhile, the insulating isolation medium is arranged at the crossing position between the two connecting strips 12 and 22 for ensuring that the driving electrode chains 1 are unable to be electrically connected with the sensing electrode chain 2.

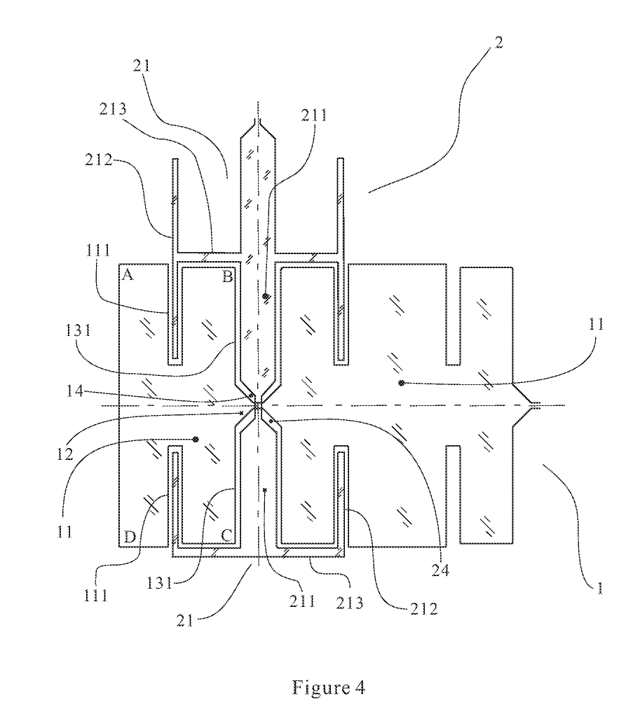

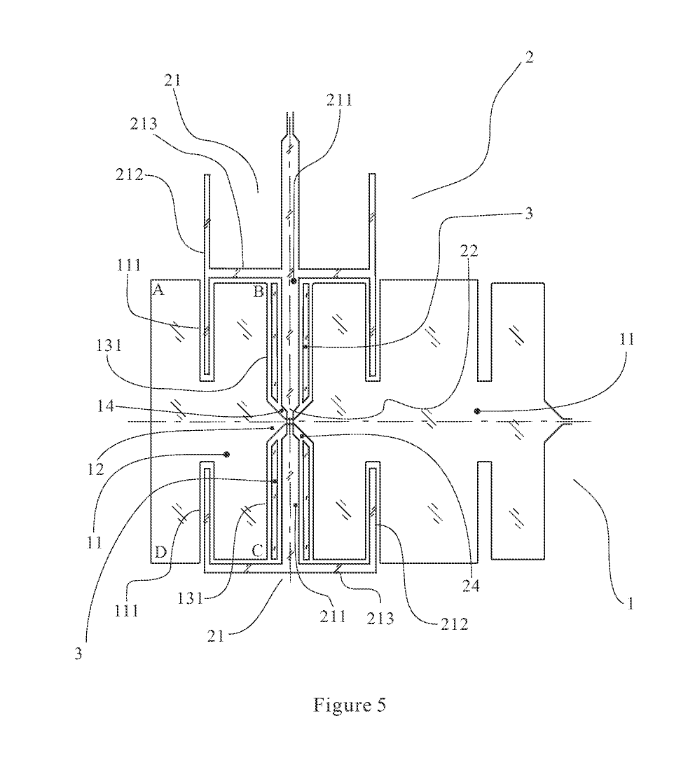

In the first embodiment of the invention, as shown in FIG. 1 to FIG. 4, all the driving electrode plates 11 are rectangular. Particularly as shown in FIG. 4, concave clearances 111 whose central lines are perpendicular to respective electrode plate edges are respectively arranged on two parallel electrode plate edges AB and CD on one driving electrode plate 11 on both sides of the driving electrode connecting strip 12. Moreover, the concave clearances 111 are symmetrically arranged on the driving electrode plates 11 by using the central lines of the driving electrode chains 1 as an axis of symmetry. Two del driving electrode connecting notches 14 which are recessed towards the driving electrode connecting strip 12 are respectively arranged on both sides of the middle part of the driving electrode connecting strip 12. Two del sensing electrode connecting notches 24 which are recessed towards the sensing electrode connecting strip 22 are respectively arranged on both sides of the middle part of the sensing electrode connecting strip 22.

In the second embodiment of the invention, as shown in FIG. 5, the difference from the first embodiment is that a dummy electrode plate 3, which is made of conductive material and is in an electric hanging state, is also arranged in the intermittent region between adjacent driving electrode plate 11 and sensing electrode plate 21. The electric hanging state means that the dummy electrode plate 3 does not have any electric contact or electrical connection relationship with any driving electrode plate 11, any sensing electrode plate 22 and any charged device. The dummy electrode plate 3 of the second embodiment is arranged in the gap 131 between two adjacent driving electrode plates 11. The dummy electrode 3 is added for realizing a power line relay in the coupling electric field, further reducing the long range power lines and further optimizing the advantage of realizing the invention.

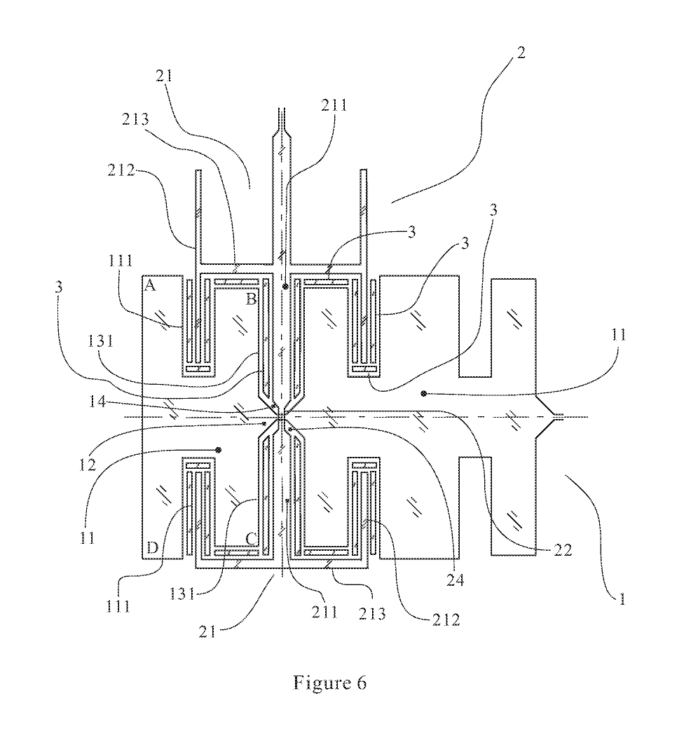

In the third embodiment of the invention, as shown in FIG. 6, the difference from the second embodiment is that the dummy electrode plate 3 is arranged not only in the gap 131 between two adjacent driving electrode plates 11, but also in the concave clearances 111 in the driving electrode plates 11. It is obvious that the advantage of the third embodiment is better than that of the second embodiment because the arranging positions of the dummy electrode plates 3 are added.

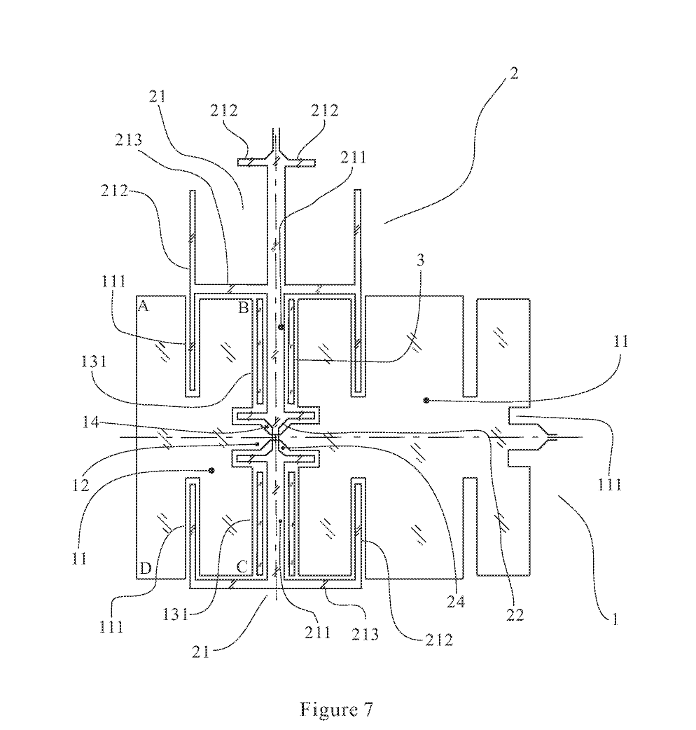

In the fourth embodiment of the invention, as shown in FIG. 7, the difference from the second embodiment is that at least one concave clearance 111 whose central line is perpendicular to the electrode plate edge is arranged on the electrode plate edge BC of one driving electrode plate 11 adjacent to the adjacent driving electrode plate 11. Meanwhile, concave clearances 111 whose central lines are perpendicular to respective electrode plate edges are respectively arranged on two parallel electrode plate edges AB and CD of the driving electrode plate 11 on both sides of the driving electrode connecting strip 12. Because the fourth embodiment more disperses the coupling electric field by adding the concave clearances 111, the advantage of the fourth embodiment is better than that of the second embodiment.

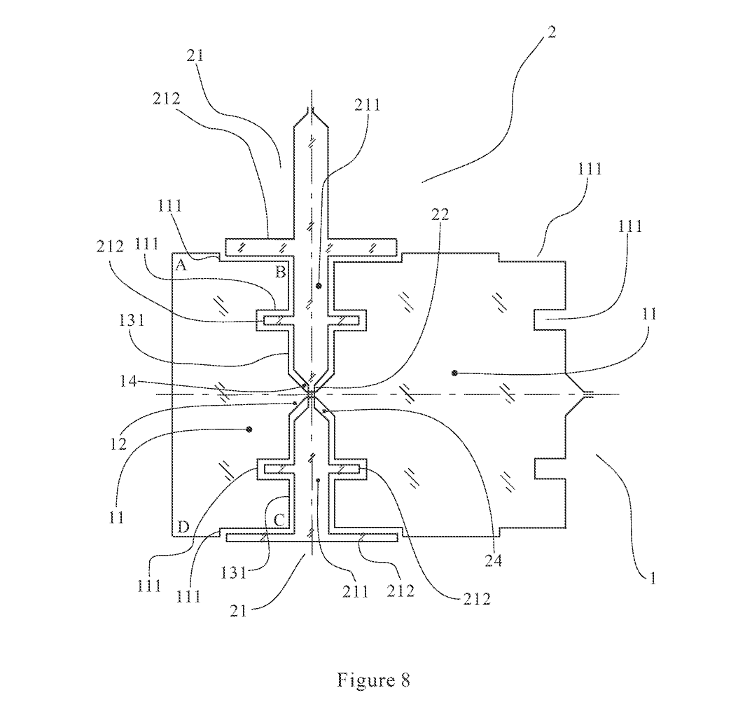

In the fifth embodiment of the invention, as shown in FIG. 8, the difference from the first embodiment is that at least one concave clearance 111 whose central line is perpendicular to the electrode plate edge is arranged on the electrode plate edge BC of only one driving electrode plate 11 adjacent to the adjacent driving electrode plate 11. The advantage of the fifth embodiment is almost identical with that of the first embodiment.

All the embodiments of the invention are used for manufacturing the conductive materials of the driving electrode chains 1, the sensing electrode chains 2 and the dummy electrode plates 3. Transparent conductive materials are adopted, such as Indium Tin Oxide (ITO) and Antimony Tin Oxide (ATO).

The driving electrode chains 1 and the sensing electrode chains 2 are electrically connected with corresponding interfaces of the data processing module of the touch screen through conductive wires, such as ITO wires, silver paste wires or metal wires.

What is claimed is:

1. A mutual capacitance touch screen to cause dispersed coupling of electrodes, comprising: at least one driving electrode chain made of conductive material, at least one sensing electrode chain made of conductive material, and a data processing module; the central line of any driving electrode chain and the central line of any sensing electrode chain are mutually vertical; the driving electrode chains are electrically connected with a driving electrode interface of the data processing module; the sensing electrode chains are electrically connected with a sensing electrode interface of the data processing module; the mutual capacitance touch screen is characterized in that:
the driving electrode chains comprise at least two driving electrode plates; two adjacent driving electrode plates are electrically connected by means of driving electrode connecting strips made of conductive material; thus, two gaps are formed between two adjacent driving electrode plates; bar-shaped concave clearances which are recessed towards the driving electrode plates are also arranged on the driving electrode plates;
the sensing electrode chains comprise at least two sensing electrode plates; the sensing electrode plates comprise gap sensing electrodes and clearance sensing electrodes electrically connected with the gap sensing electrodes; two adjacent sensing electrode plates are electrically connected together by means of the sensing electrode connecting strips which are respectively electrically connected with two adjacent gap sensing electrodes; the sensing electrode connecting strips are made of conductive material.
the shapes of the sensing electrode plates and the arrangement of the driving electrode chains and the sensing electrode chains enable all the driving electrode plates and the sensing electrode plates to satisfy that the driving electrode connecting strips between two adjacent driving electrode plates are intersected but not in electric contact with the sensing electrode connecting strips of a pair of adjacent sensing electrode plates in spatial positions; respective gap sensing electrodes of two adjacent sensing electrode plates are respectively positioned in two gaps between two adjacent driving electrode plates; respective clearance sensing electrodes of two adjacent sensing electrode plates are respectively positioned in the respective concave clearances of two driving electrode plates; the driving electrode plates and the sensing electrode plates are not in any electric contact.

2. The mutual capacitance touch screen to cause dispersed coupling of electrodes according to claim 1 is characterized in that:
the sensing electrode plates also comprise at least one electrode plate inner connecting strip made of conductive material; the electric connection among the gap sensing electrodes and each clearance sensing electrode plate is realized by means of the electrode plate inner connecting strips for respectively electrically connecting the clearance sensing electrode plates with the gap sensing electrodes.

3. The mutual capacitance touch screen to cause dispersed coupling of electrodes according to claim 1 is characterized in that:
two del driving electrode connecting notches which are recessed towards the driving electrode connecting strips are respectively arranged on both sides of the middle parts of the driving electrode connecting strips; two del sensing electrode connecting notches which are recessed towards the sensing electrode connecting strips are respectively arranged on both sides of the middle parts of the sensing electrode connecting strips.

4. The mutual capacitance touch screen to cause dispersed coupling of electrodes according to claim 1 is characterized in that:
the central lines of the driving electrode chains are the centroid connecting lines of each driving electrode plate of the driving electrode chains; the central lines of the sensing electrode chains are the centroid connecting lines of each sensing electrode plate of the sensing electrode chains.

5. The mutual capacitance touch screen to cause dispersed coupling of electrodes according to claim 1 is characterized in that:
the driving electrode chains are positioned in the same driving electrode plane; the sensing electrode chains are positioned in the same sensing electrode plane; the driving electrode plane and the sensing electrode plane are mutually parallel.

6. The mutual capacitance touch screen to cause dispersed coupling of electrodes according to claim 5 is characterized in that:
an insulating medium is arranged between the driving electrode plane and the sensing electrode plane.

7. The mutual capacitance touch screen to cause dispersed coupling of electrodes according to claim 1 is characterized in that:
the driving electrode chains and the sensing electrode chains are positioned in the same electrode plane; isolation media made of insulating material are arranged among the driving electrode connecting strips and the sensing electrode connecting strips which are mutually crossed, so that the driving electrode chains are unable to be electrically connected with the sensing electrode chains.

8. The mutual capacitance touch screen to cause dispersed coupling of electrodes according to claim 1 is characterized in that:
a dummy electrode plate, which is made of conductive material and is in an electric hanging state, is also arranged in the intermittent region between adjacent driving electrode plate and sensing electrode plate; the electric hanging state means that the dummy electrode plate does not have any electric contact or electrical connection relationship with any driving electrode plate, any sensing electrode plate and any charged device.

9. The mutual capacitance touch screen to cause dispersed coupling of electrodes according to claim 1 is characterized in that:
the driving electrode plates are rectangular;
at least one concave clearance whose central line is perpendicular to the electrode plate edge is arranged on the electrode plate edge of one driving electrode plate adjacent to an adjacent driving electrode plate;
optionally, concave clearances whose central lines are perpendicular to respective electrode plate edges are respectively arranged on two parallel electrode plate edges of one driving electrode plate on both sides of the driving electrode connecting strips;
optionally, at least one concave clearance whose central line is perpendicular to the electrode plate edge is arranged on the electrode plate edge of one driving electrode plate adjacent to an adjacent driving electrode plate; meanwhile, concave clearances whose central lines are perpendicular to respective electrode plate edges are respectively arranged on two parallel electrode plate edges of one driving electrode plate on both sides of the driving electrode connecting strips.

10. The mutual capacitance touch screen to cause dispersed coupling of electrodes according to claim 9 is characterized in that:
the concave clearances are symmetrically arranged on the driving electrode plates by using the central lines of the driving electrode chains as an axis of symmetry.
